(19) United States
(12) Patent Application Publication
(10) Pub. No.: US 2010/0101207 A1
(43) Pub. Date: Apr. 29, 2010

(54) TURBINE DEVICE

(75) Inventor: Torbjörn Eriksson, Stockholm (SE)

Correspondence Address: SCHWEGMAN, LUNDBERG & WOESSNER, P.A., P.O. BOX 2938, MINNEAPOLIS, MN, 55402, US

(73) Assignee: ERIKSSON DEVELOPMENT AND INNOVATION AB, STOCKHOLM (SE)

(21) Appl. No.: 12/530,420

(22) PCT Filed: Mar. 7, 2008
(86) PCT No.: PCT/SE08/50258

§ 371 Date: Dec. 28, 2009

Related U.S. Application Data
(60) Provisional application No. 60/969,997, filed on Sep. 5, 2007.

(30) Foreign Application Priority Data
Mar. 9, 2007 (SE) 0700586-1

(51) Int. Cl. F01K 23/16; F01D 11/08; F01D 25/12; F02C 6/04

(52) U.S. Cl. 60/39.182; 415/173.1; 415/177

(57) ABSTRACT

The invention relates to a turbine device comprising a gas turbine portion and concentrically with the gas turbine portion arranged steam turbine portion, where the gas turbine portion and the steam turbine portion have a common rotor (28). The invention also relates to a device for use in a compressor (1) or a turbine (3, 4, 5), where the rotor blades (9) of the rotor (28) as well as the stator blades (19) of the stator (21) comprise fluid channels (23, 26) for collecting heat in the compressor or the turbine. The objective of the invention is to provide a gas turbine engine with high power density and coefficient of efficiency.

### TECHNICAL FIELD

The invention relates to a turbine device comprising a gas turbine portion and a steam turbine portion. The invention also relates to a device for use in a compressor or a turbine, wherein rotor blades as well as stator blades comprise fluid channels.

### BACKGROUND OF THE INVENTION

Gas turbine engines are used for the conversion of the chemical energy of a fuel into mechanical energy in a number of situations. There, a gas turbine is driven, i.e. is brought to rotate, by a gas flow which is generated by combustion of the fuel. The gas turbine usually drives a compressor in order to, in conformity with the turbo-charger of a piston engine, compress air and supply the combustion chamber with an increased amount of oxygen.

Often, more than one gas turbine and compressor, respectively, are used in a gas turbine engine, which operate in series at pressures of different magnitude. For instance, a first gas turbine stage can operate at a high pressure, and a subsequent second gas turbine stage can operate at a lower pressure.

The advantage of the gas turbine engine is, in general, that the engine can provide high power at low weight. A drawback has traditionally been that the efficiency, i.e. the utilisation of the chemical energy of the fuel, is low.

In order to make use of as much as possible of the chemical energy of the fuel, the heat generated by the combustion can also be utilised in a steam turbine within the engine. Channels for some sort of fluid are then arranged at and/or after the combustion chamber in order to transfer heat from the hot combustion gases to the fluid. Normally, the fluid thereby transforms from liquid to steam and in some cases to overheated steam (gas), which steam drives the steam turbine. When converting the chemical energy of a fuel to mechanical energy by means of a gas turbine in combination with a steam turbine in this manner, a higher efficiency is achieved than the one achieved by a gas turbine exclusively.

U.S. Pat. No. 4,333,309 describes a gas turbine engine with an integrated steam turbine. Liquid is vaporized in separate pipes and channels that are arranged e.g. in the combustion chamber and the gas turbine blades. The steam drives a steam turbine, whereby the steam is allowed to condense in e.g. the compressor of the engine in order to heat the compressor and thereby prevent the formation of ice. The drawbacks of gas turbine engines of this type their relatively great mass and size. Further, they comprise many moving parts and still show a relatively low efficiency.

Thus, there is a need for a turbine device that is relatively light-weight and compact, has few moving parts and a high efficiency.

### SUMMARY OF THE INVENTION

The objective of the present invention is to provide a turbine device which avoids the drawbacks of the prior art. This objective is obtained by means of the turbine device in accordance with the enclosed independent claims. Preferred embodiments are set forth in the enclosed dependent claims

According to a first aspect, the invention provides a turbine device which includes a plurality of rotor wheels and a plurality of stator discs. The turbine device further comprises a gas turbine portion and a steam turbine portion. The gas turbine portion and the steam turbine portion are concentrically arranged and one portion is arranged radially outside the other.

According to a second aspect, the invention provides a device for use in a compressor or in a turbine, which device comprises a plurality of rotor wheels with rotor blades and also a plurality of stator discs with stator blades. The stator discs and the stator blades comprise stator fluid channels and the rotor wheels and rotor blades comprise rotor fluid channels. In the fluid channels, heat is absorbed by a fluid that flows in the channels.

### BRIEF DESCRIPTION OF THE FIGURES

FIG. 1 shows a schematical sketch of a gas turbine engine with a compressor, a combustion chamber and gas turbine.

FIG. 2 shows a schematical sketch of a gas turbine engine with a compressor, a combustion chamber, a first gas turbine stage and a second gas turbine stage.

FIG. 3a shows a radial cross-section through a rotor wheel in accordance with the present invention.

FIG. 3b shows an axial cross-section through a turbine device with a gas turbine portion and a steam turbine portion in accordance with the present invention.

FIG. 3c shows a radial cross-section through a stator disc in accordance with the present invention.

FIG. 4 shows a cut-out enlargement of the axial cross-section of FIG. 3b.

### DETAILED DESCRIPTION OF THE INVENTION

The objective of the invention is to provide a turbine device with high efficiency, superior to the traditional diesel engine, and with few moving parts. The device shall provide high power in relation to weight and size.

The turbine device in accordance with the invention preferably comprises a gas turbine portion as well as a steam turbine portion. The gas turbine portion and the steam turbine portion are concentric and drive the same turbine shaft. The turbine device has a plurality of rotor and stator blades which are arranged on a rotor and a stator, respectively, which rotor and stator are common for the both turbine portions. Hereby the number of moving parts, the weight and the size are reduced in comparison with a conventional turbine engine having a gas and a steam turbine portion. The rotor blades are divided into gas turbine blades and steam turbine blades. Correspondingly, the stator blades are divided into gas turbine blades and steam turbine blades. The gas turbine blades are arranged in the gas turbine portion and the steam turbine blades are arranged in the steam turbine portion. In the gas turbine portion, a combustion gas drives the rotor by acting on the gas turbine blades of the rotor. At the same time, the steam turbine blades of the rotor are acted on by a gaseous fluid (below referred to as “steam”) in the steam turbine portion, whereby additional drive is supplied to the rotor. The stator, which is common for the gas turbine portion and the steam turbine portion, has a number of stator blades which extend through the both concentric portions in the form of steam turbine blades and gas turbine blades, respectively.

It is advantageous to arrange fluid channels in the rotor blades as well as in the stator blades. Thereby, heat from the gas that drives the blades, or from the air that is compressed by the blades, can effectively be absorbed by a fluid that flows in the channels.

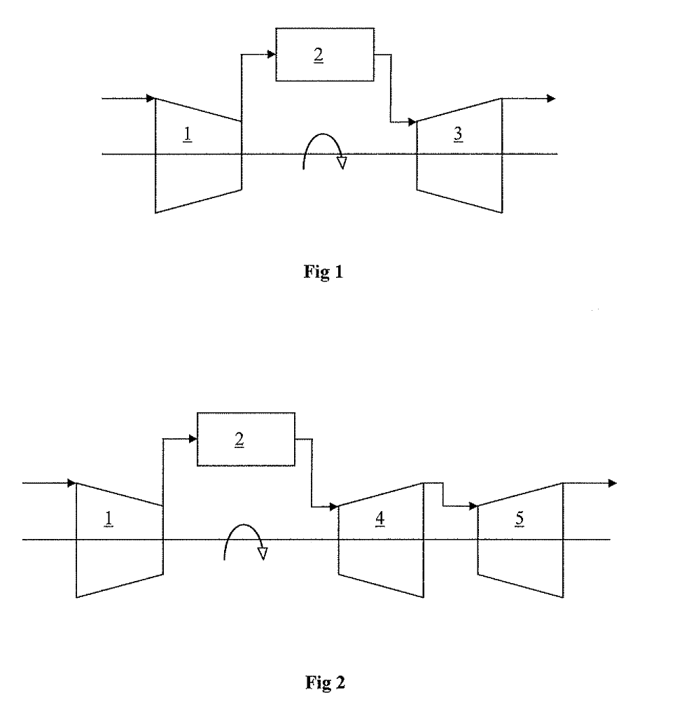

In FIG. 1, a schematic diagram of a conventional gas turbine engine with a compressor 1, a combustion chamber 2 and a gas turbine 3 is shown. The arrows illustrate how air is drawn into the compressor 1 where it is compressed before it is delivered to the combustion chamber 2. In the combustion chamber 2, fuel is supplied and the air/fuel mix is ignited. Combustion gas flows at high speed out of the combustion chamber to the gas turbine 3, whereby the gas turbine 3 is brought to rotation. The gas turbine 3 and the compressor 1 are mounted on a common axis, so that the gas turbine 3 drives the compressor 1. This gas turbine engine is therefore referred to as “single-spool”.

FIG. 2 shows a schematic diagram of another conventional gas turbine engine with a compressor 1, a combustion chamber 2, a first gas turbine stage 4 and a second gas turbine stage 5. This gas turbine engine thus differs from the gas turbine engine in FIG. 1 in that utilisation of the energy of the combustion gas is made in two separate gas turbines 4, 5. Here, the both turbine stages 4, 5 can operate at different pressures and at separate and variable speeds. The advantage of this is that the gas turbine engine can operate at variable speed.

Also the compression can be performed in several steps in gas turbine engines. In that case, a high pressure compressor with a corresponding high pressure turbine is arranged on a first axis, and a low pressure compressor is arranged with a corresponding low pressure turbine on a second axis. When two axes, which accordingly rotate separately from each other, are put to use the gas turbine engine is referred to as “twin-spool”. So called “multiple spool” gas turbine engines are also known. In these a plurality of axes, which rotate separately from each other, are used between the compressor stage and the gas turbine stage, or between the gas turbine stage and e.g. the drive axis of a vehicle.

The turbine device according to the present invention can replace the conventional gas turbine 3 located after the combustion chamber 2 in FIG. 1. The turbine device can also replace the high and/or low pressure turbines 4, 5 after the combustion chamber 2 in FIG. 2, or other gas turbines in multiple spool applications.

The invention also relates to a device for use in a compressor or in a turbine, and can thus also replace the compressor 1 in FIG. 1 or 2.

Below, a preferred embodiment of the invention is described, wherein a turbine device comprises both a gas turbine portion and a steam turbine portion. In this embodiment, the steam turbine portion is arranged outside the gas turbine portion. However, it is to be appreciated that the steam turbine portion also can be arranged inside the gas turbine portion, and that the invention covers both alternatives.

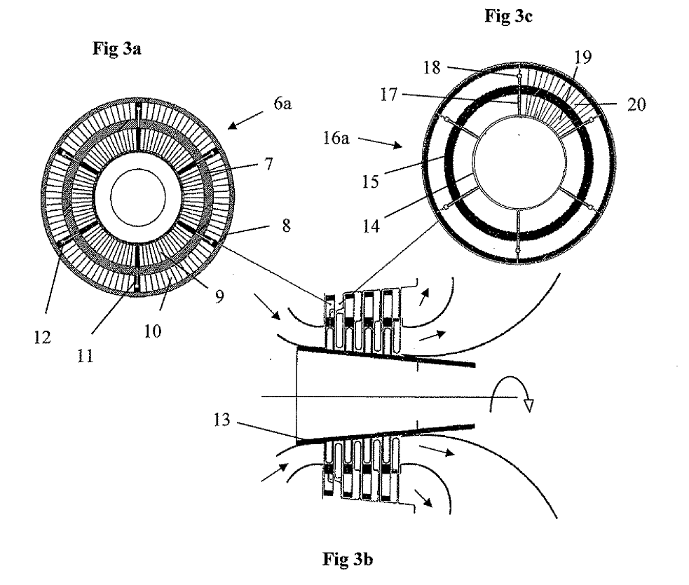

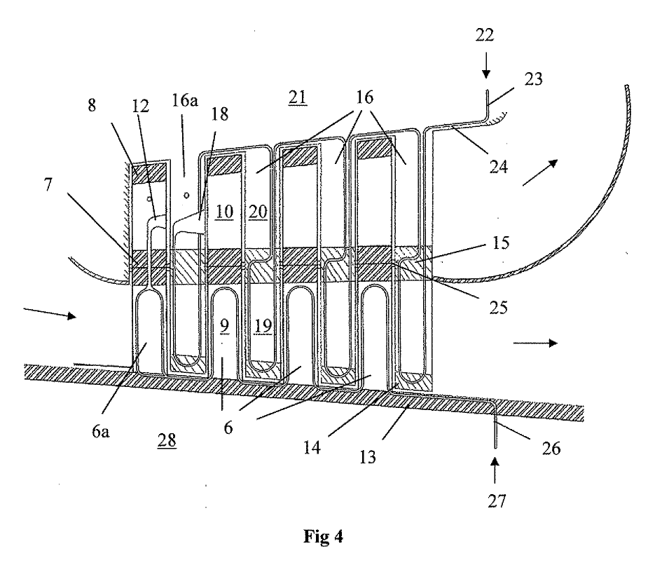

In FIG. 3a, a rotor wheel 6a is schematically shown. FIGS. 3b and 4 illustrate by means of an axial cross-section how a plurality of rotor wheels 6, 6a form a conical tubular rotor hub 13. The rotor wheel 6a that is arranged furthermost to the left in FIG. 3b differs from the other rotor wheels 6 in that it comprises rotor steam pipes 11 and rotor steam nozzles 12, which are elucidated below. The rotor wheels 6, 6a comprise a plurality of gas turbine blades 9, which are arranged between the rotor hub 13 and an inner rotor rim 7, and also a plurality of steam turbine blades 10, which are arranged between the inner rotor rim 7 and an outer rotor rim 8. The rotor hub can also be straight instead of conical, then rotor blades of differing length are used along the rotor axis. The rotor steam pipes 11, six pieces in FIG. 3a, are arranged between the rotor hub 13 and the outer rotor rim 8.

The stator disc 16a in FIG. 3c has a design resembling that of the rotor wheel 6a. The stator disc 16a furthermost to the left in FIG. 3b differs from the other stator discs 16 by the presence of stator steam pipes 17 and stator steam nozzles 18. The turbine blades 19, 20 of the stator are divided into steam turbine blades 20, which are arranged between the stator wall 24 (see FIG. 3b) and an outer stator rim 15, and also gas turbine blades 19, which are arranged between the outer stator rim 15 and an inner stator rim 14. The outer stator rim 15, which thus is arranged between the stator wall 24 and the inner stator rim 14, is located at the interface between the steam turbine portion and the gas turbine portion. The stator steam pipes 17, six pieces in FIG. 3c, are arranged between the stator wall 24 and the inner stator rim 14.

The term “rotor wheel” is considered depictive since the rotor hub 13, the rotor blades 9, 10 and the outer rotor rim 8 rotate and resemble the hub, spokes and felloe of a traditional wheel, see FIG. 3a. A corresponding wording, “stator wheel”, could for the sake of simplicity be used for the stator equivalent 14, 19, 20, 24. However the term “stator disc” is instead used herein, since the stator wheel does not rotate.

FIG. 4 illustrates the axial cross-section through the turbine device of FIG. 3b in more detail. Here, a number of rotor wheels 6, 6a and a number of stator discs 16, 16a, which are alternately arranged in the axial direction, are shown. It is to be appreciated that the rotor wheels 6, 6a comprise a part of the rotor 28 and thus rotate, whereas the stator discs 16, 16a are rigidly attached to the stationary stator 21. The rotor 28 and its rotor wheels 6, 6a as well as the stator discs 16, 16a are enclosed in the turbine volume which is defined by the stator wall 24. The figure shows the rotor 28 with its rotor blades 9, 10 which are mounted at the rotor hub 13 and project radially out therefrom, as well as inner 7 and outer 8 rotor rims. From the stator wall 24 the stator blades 9, 10 project radially towards the central longitudinal axis of the rotor 28. The inner rotor rims 7 of the rotor 28 are located at the same radial distance from the central longitudinal axis of the turbine device as are the outer stator rims 15 of the stator 21.

Sealings 25, e.g. labyrinth sealings, are arranged between each rotor wheel inner rotor rim 7 and the adjacent stator disc outer stator rim 15. Thereby, an inner conical tubular volume is radially delimited by the rotor hub 13, the inner rotor rims 7, the outer stator rims 15 and also the sealings 25 between the inner rotor rims 7 and the outer stator rims 15. The rotor hub 13 constitutes the radially inner boundary surface of the inner tubular volume, whereas the outer boundary surface is formed by the inner rotor rims 7, the outer rotor rims 15 and also the sealings between the inner rotor rims 7 and the outer rotor rims 15. Within this inner tubular volume, the gas turbine blades 9 of the rotor and the gas turbine blades 19 of the stator are located. This inner tubular volume constitutes the gas turbine portion of the turbine device. As shown in FIG. 3b and FIG. 4, the inner tubular volume is supplied with combustion gas from the left. The energy of the combustion gas, in the form of pressure and flow speed, makes the rotor rotate.

An outer conical tubular volume is defined by the stator wall 24, the outer stator rims 15, the inner rotor rims 7 and the sealings 25 between the outer stator rims 15 and the inner rotor rims 14. The stator wall 24 constitutes the radially outer boundary surface of the outer tubular volume, whereas the inner boundary surface is formed by the outer stator rims 15, the inner rotor rims 7 and also the sealings 25 between the outer stator rims 15 and the inner rotor rims 7. Within this outer tubular volume, the steam turbine blades 10, 20 of the rotor 28 and also of the stator 21 are located. This outer tubular volume constitutes the steam turbine portion of the turbine device

In accordance with the discussion above and as can be seen in FIG. 3b and FIG. 4, the outer tubular volume is arranged radially outside the inner tubular volume within the turbine volume. The outer tubular volume, i.e. the steam turbine portion, and the inner tubular volume, i.e. the gas turbine portion, are thus concentrically arranged. Furthermore, the extensions of the outer tubular volume and the inner tubular volume coincide axially.

FIG. 4 also shows fluid channels 23, 26 of the turbine device. Rotor fluid channels 26 run in the rotor hub 13 and in the gas turbine blades 9 of the rotor. The inlets of the rotor fluid channels 26 are preferably arranged inside the rotor hub 13, and the channels 26 then run axially within the hub 13 and out to each gas turbine blade 9 and back to the hub 13 between each gas turbine blade 9. The fluid may, by means of an alternative arrangement of the fluid channels 26, be distributed as desired to different sections of the rotor and its gas turbine blades 9 depending on requirements. The fluid that is supplied to the rotor fluid channels 26 is in FIG. 4 supplied from the inside of the rotor hub 13. Correspondingly, stator fluid channels 23 run in the stator 21 and its stator blades 19, 20. The inlets 22 of the stator fluid channels 23 are preferably arranged outside the stator wall 24. The fluid that is supplied to the stator fluid channels 23 is supplied from the outside of the stator 21.

The purpose of the fluid channels 23, 26 is to heat, vaporize, and overheat the fluid that is present in the channels by means of the heat that is supplied to the inner tubular volume, i.e. the gas turbine portion of the turbine device, by means of the hot gas. Said fluid channels also act to keep the material temperature at acceptable levels. The rotor fluid channels 26 exclusively run through the gas turbine blades 9 of the rotor. As shown in FIG. 4, however, the rotor fluid channels 26 of the leftmost rotor wheel 6a in FIG. 4 run through the inner rotor rim 7 to the rotor steam nozzles 12, which are arranged between the inner rotor rim 6 and the outer rotor rim 8 in the steam turbine portion of the turbine device.

The stator fluid channels 23 run from the stator wall 24, through the stator steam turbine blades 20 and through the outer stator rim 15 to the stator gas turbine blades 19. Thereby, also the fluid in the stator fluid channels 23 can be heated, vaporized and overheated in the inner tubular volume, which constitutes the gas turbine portion of the turbine device. In the steam turbine device, the fluid that flows through the fluid channels of the steam turbine blades of the stator 20 neither absorbs nor emits heat, the fluid channels in the steam turbine blades 20 of the stator merely function to lead the fluid to the fluid channels in the gas turbine blades 19 of the stator. As shown in FIG. 4, the stator fluid channels end in stator steam nozzles 18 in the stator disc 16a furthermost to the left in FIG. 4, between the stator wall 24 and the outer stator rim 15 in the steam turbine portion of the turbine device.

The fluid channels 26 in the gas turbine blades 9 of the rotor are all connected to collecting channels within the rotor steam pipes 11 which lead to the rotor steam nozzles 12, which are arranged on the rotor steam pipes 11 of the leftmost rotor wheel 6a in FIG. 4. Correspondingly, the fluid from the fluid channels in the stator blades 19, 20 is collected by means of collecting channels which are arranged within the stator steam pipes 17. The stator steam nozzles 18 are arranged on the stator steam pipes 17 of the leftmost stator discs 16a in FIG. 4.

The axial position at which the combustion gas that is supplied to the gas turbine portion of the turbine device meets the first turbine wheel 6a, i.e. the leftmost wheel in FIG. 4, defines the inlet of the gas turbine portion. Further, the steam turbine inlet is defined by the axial position at which steam is first supplied to the steam turbine portion of the turbine device, i.e. at the rotor steam nozzles 12 or the stator steam nozzles 18. Thus, in the embodiment which is shown in FIG. 4, the left-hand surface of the leftmost rotor wheel 6a defines the inlet of the gas turbine portion. The right-hand surface of the same rotor wheel 6a defines the inlet of the steam turbine.

As shown in FIG. 4, the outer tubular volume, i.e. the steam turbine portion of the turbine device, is supplied with steam from the rotor steam nozzles 12 and the stator steam nozzles 18 to the left in FIG. 4. The energy of the steam, in the form of pressure and flow speed, makes the rotor 28 rotate.

Consequently, both the combustion gas and the steam contribute to the rotation of one and the same rotor 28, which increases the power density and the efficiency of the device. The combustion gas thus drives the rotor wheels 6, 6a in cooperation with the steam which also drives the rotor wheels 6. The rotor 28 which is enclosed in the turbine volume is thereby brought to rotation by the gas turbine portion and the steam turbine portion in cooperation. The gas turbine portion and the steam turbine portion thus have a common rotor 28. Furthermore, the gas turbine portion and the steam turbine portion have a common stator 21.

The gas turbine blades 9, 19 of the rotor and of the stator and also the rotor hub 28 all function as heat exchangers by means of the fluid channels 23, 26 in which the fluid flows. Preferably, the fluid is in liquid state on supply to the rotor fluid channels 26 and the stator fluid channels 23, respectively, whereas the fluid is gaseous when it leaves the rotor fluid channels 26 through the rotor steam nozzles 12 and the stator fluid channels 23 through the stator steam nozzles 18, respectively. The fluid channels 23, 26 of the rotor and the stator are in FIG. 4 connected in parallel.

The rotor fluid channels 26 and the stator fluid channels 23 can also be connected in series. Thereby the fluid may first be led through the stator fluid channels and subsequently through the rotor fluid channels 26. In that case, the stator fluid channels 23 are subsequently, after the stator blades 19, 20, led to the inside of the rotor hub 13, from where the fluid is led to the rotor fluid channels 26. An advantage of such an arrangement is that the fluid, when it reaches the gas turbine blades 9 of the rotor, already has been vaporized in the gas turbine blades 19 of the stator, whereby it is ensured that no fluid in liquid state weights the gas turbine blades 9 of the rotor. Alternatively, the fluid may first be led through the rotor fluid channels 26 and subsequently through the stator fluid channels 23. Then, the rotor fluid channels 26, after passage through the gas turbine blades 9 of the rotor, are led to the stator 21, whereafter the fluid is led to the stator fluid channels 23. In this case, the right-hand surface of the first, in the flow direction of the combustion gas, stator disc 16 defines the inlet of the steam turbine portion.

The fluid channels can also be arranged outside the rotor and stator blades, respectively, they can e.g. be formed as pipes and be placed close to the hot combustion gas, e.g. before and/or after the entrance of the hot combustion gas into the gas turbine portion, as shown in U.S. Pat. No. 4,333,309, or after the turbine portion.

In FIG. 4, the first turbine wheel 6a, as seen in the flow direction of the combustion gas, is a rotor wheel. In accordance with an alternative embodiment the first turbine wheel, in the flow direction, is instead a stator disc. Both embodiments are feasible. Depending on whether a rotor wheel or a stator disc is arranged first, the inlet of the steam turbine will be shifted axially.

For optimisation of the turbine device, the dimension of the gas turbine portion and the steam turbine portion, respectively, can be varied radially. The ratio of the size of the inner tubular volume to the outer tubular volume is dependent on the radial position of the inner rotor rim 7 and the outer stator 15 rim. The gas turbine portion share of the total turbine volume may be increased by shifting the inner rotor rim 7 and the outer stator rim 15 radially outwards, the gas turbine blades 9, 19 must then be lengthened whereas the steam turbine blades 10, 20 are shortened. Correspondingly, the steam turbine portion share of the total turbine volume may thus be increased by shifting the inner rotor rim 7 and the outer rotor rim 15 radially inwards.

It is also possible to optimise the turbine device by varying the axial dimensions of the gas turbine portion and the steam turbine potions, respectively. This may e.g. be achieved by changing the construction of the rotor and/or stator discs 6, 16. Hereby, the effective part of the steam turbine portion may e.g. be reduced axially by excluding the steam turbine blades 10 of the rotor in e.g. the rear, as seen in the flow direction, rotor wheels 6. Then, at the same time, also the rear, as seen in the flow direction, steam turbine blades 20 of the stator can be excluded. In this manner, the effective part of the steam turbine portion is reduced by axial shortening The axially effective part is here defined as the part which is contained between the first rotor wheel 6a or the first stator disc 16a and the last rotor wheel or stator disc that operate in the steam turbine portion. Correspondingly, the size of the corresponding effective part of the gas turbine portion may be reduced by excluding the gas turbine blades 9, 19 of the rear rotor wheels and stator discs.

The turbine device can preferably be customised so that the pressure in the gas turbine portion essentially corresponds to the pressure in the steam turbine portion along the axial length of the turbine device. The smaller the pressure difference between the gas turbine portion and the steam turbine portion, the smaller the pressure exerted by the combustion gas in the gas turbine portion, or the steam in the steam turbine portion, against the sealings 25. In this manner, the combustion gas can flow through the gas turbine portion and act on the gas turbine blades 9 of the rotor, and the steam can flow through the steam turbine portion and act on the steam turbine blades 10 of the rotor, with virtually no combustion gas ending up in the steam turbine portion due to pressure difference, and vice versa.

In accordance with another preferred embodiment, one or more steam nozzles are arranged prior to, as seen in the direction of the flow of the combustion gas, the first rotor wheel 6a or the first stator disc 16a in the steam turbine portion. In this embodiment, the steam nozzles are accordingly not arranged in the rotor wheels 6a or the stator discs 16a. The steam nozzles are instead arranged separately before the inlet of the steam turbine portion. The rotor fluid channels and the stator fluid channels, which can be connected in series or in parallel, are led to these steam nozzles. Now, the effective part of the gas and or steam turbine portions can consequently also be varied by excluding the rotor or stator blades, respectively, in the first rotor wheels 6a and stator discs 16a, respectively.

In FIG. 4, an embodiment where the gas turbine portion of the turbine device is arranged radially inside the steam turbine portion is shown. In accordance with an alternative embodiment, the gas turbine portion of the turbine device is instead arranged outside the steam turbine portion. In such case, the hot combustion gas is led to the outer tubular volume, and the fluid channels within the rotor wheels and stator discs, respectively, are arranged such that the heat in the outer tubular volume is absorbed by the fluid, whereafter the fluid is led to the inner tubular volume, where it drives the steam turbine portion.

The device for use in a compressor or in a turbine, where the rotor blades as well as the stator blades comprise fluid channels, can when put to use in a turbine collect heat from the gas that drives the blades. When the device is put to use in a compressor, which can be arranged before a combustion chamber in order to supply an increased amount of air to the combustion chamber, it can effectively collect heat from the air that is compressed by the blades. The rotor and stator blades of the compressor then comprise fluid channels, in which a fluid that absorbs the heat flows. The compressor heat that is generated by the compression of the air is transferred to the fluid and can thereby in this way be utilised. This cooling of the air in the compressor also results in that the density of the air increases, whereby a yet larger amount can be supplied to the combustion chamber. The fluid channels of the device for use in a compressor or in a turbine can be designed in accordance with the fluid channels 23, 26 as described in connection with the turbine device above.

In order to obtain a high coefficient of efficiency, the compressor of a turbine engine may include fluid channels in the rotor blades as well as in the stator blades. Furthermore, the gas turbine portion of the engine may include fluid channels in the rotor blades as well as in the stator blades. A fluid can then e.g. be led through the turbine engine as follows: the stator blades of the compressor→the rotor blades of the compressor→the stator blades of the gas turbine portion→the rotor blades of the gas turbine portion. Finally, the fluid, which is transformed from liquid to steam, is led to the steam turbine portion of the turbine engine, which steam turbine portion may be concentric with the gas turbine portion of the turbine engine.

The fluid or a part of the fluid which is supplied with heat in the fluid channels of the rotor and stator blades can in the form of steam be injected into the combustion chamber for NOx regulation. The heated fluid can also be used for heating purposes.

The fluid channels in the rotor wheels and stator discs, respectively, imply that the rotor wheels and stator discs with the rotor and stator blades, respectively, are cooled by the fluid that flows in the channels. This cooling enables the manufacturing of the rotor wheels and stator discs with the rotor and stator blades, respectively, from titanium or titanium alloys. Other conceivable materials for the rotor wheels and stator discs with rotor and stator blades, respectively, comprise e.g. CrNi alloys.

The rotor and stator blades, respectively, are preferably manufactured by precision casting or by the FMD method (Fused Deposition Modelling), wherein liquid titanium is deposited in a plurality of layers so that a three-dimensional structure is achieved. Hereby, complex fluid channels within the rotor and stator blades can be realised.

What is claimed is:

1. A turbine device comprising:
a plurality of rotor wheels, and
a plurality of stator discs,
which turbine device comprises a gas turbine portion and a steam turbine portion,
the gas turbine portion and the steam turbine portion are concentrically arranged and that one portion is arranged radially outside the other.

2. The turbine device according to claim 1, wherein the gas turbine portion and the steam turbine portion have at least one common stator disc.

3. The turbine device according to claim 1, wherein the gas turbine portion and the steam turbine portion have at least one common rotor wheel.

4. The turbine device according to claim 1, wherein the stator discs comprise stator blades arranged between a wall of the stator and inner stator rims, and the rotor wheels comprise rotor blades arranged between a hub of the rotor and outer rotor rims.

5. The turbine device according to claim 4, wherein the stator discs further comprise outer stator rims arranged between the wall of the stator and the inner stator rims, and wherein the rotor wheels further comprise inner rotor rims arranged between the hub of the rotor and the outer rotor rims.

6. The turbine device according to claim 5, wherein sealings are arranged between the inner rotor rims and the outer stator rims, so that the gas turbine portion is radially separated from the steam turbine portion by the inner rotor rims, the outer stator rims and also the sealings between the inner rotor rims and the outer stator rims.

7. The turbine device according to claim 1, wherein the stator discs comprise stator fluid channels, in which heat is absorbed by a fluid that flows in the channels.

8. The turbine device according to claim 1, wherein the rotor wheels comprise rotor fluid channels, in which heat is absorbed by a fluid that flows in the channels.

9. The turbine device according to claim 1, wherein the stator discs comprise stator fluid channels, the rotor wheels comprise rotor fluid channels, and wherein heat is absorbed by a fluid that flows in the stator fluid cannels and in the rotor fluid channels, and
wherein the stator fluid channels and the rotor fluid channels end in the steam turbine portion and are connected in parallel.

10. The turbine device according to claim 1, wherein the stator discs comprise stator fluid channels, the rotor wheels comprise rotor fluid channels, and wherein heat is absorbed by a fluid that flows in the stator fluid cannels and in the rotor fluid channels, and
wherein the stator fluid channels and the rotor fluid channels end in the steam turbine portion and are connected in series.

11. The turbine device according to claim 1, wherein the gas turbine portion is arranged radially outside the steam turbine portion.

12. The turbine device according to claim 1, wherein the steam turbine portion is arranged radially outside the gas turbine portion

13. The turbine device according to claim 4, wherein the rotor blades and the stator blades are made from titanium.

14. A device for use in a compressor or in a turbine, comprising:
a plurality of rotor wheels with rotor blades and also a plurality of stator discs with stator blades wherein the stator discs and the stator blades comprise stator fluid channels and the rotor wheels and rotor blades comprise rotor fluid channels, wherein heat is absorbed by a fluid that flows in the stator fluid channels and the rotor fluid channels.
